(19) United States
(12) Patent Application Publication
(10) Pub. No.: US 2007/0289184 A1
(43) Pub. Date: Dec. 20, 2007

(54) Suspended, mobile, greeting card display

(76) Inventor: Kui Eng Cheng, Hong Kong (HK)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/413,036

(22) Filed: Apr. 27, 2006

(51) Int. Cl. G09F 7/22; G09F 1/00

(52) U.S. Cl. 40/617; 40/124.06; 40/124.01

(57) ABSTRACT

A plurality of sheet panels of a mobile is suspended for multiple freedoms of movement from a support mountable on a horizontal supporting surface. The support is unfoldable from a compact position suitable for storage and transport to a display position in which the sheet panels of the mobile display a greeting card message.

### BACKGROUND OF THE INVENTION

1. Field of the Invention

The present invention is generally directed to greeting cards and, more particularly to a suspended, mobile, greeting card display having freedom of movement especially in response to air currents.

2. Description of the Related Art

Greeting cards bearing a message of greeting, congratulation or other sentiment are usually sent or given on a special occasion or holiday, or sometimes for no reason at all. The cards are typically imprinted with a commercial message, or are blank to allow a customized message to be written thereon. A typical card structure has at least one panel, and preferably a plurality of panels which, when opened, reveal either sequential parts of the message, or the entire message. The panels are generally formed of a paper sheet stock that is stiff enough to self-support a two-panel greeting card when placed, on edge, on a horizontal support surface, such as a desk, shelf, or mantel, in a partially open position.

As advantageous as greeting cards are for conveying social expression messages, the cards are not well suited for continuous display. For example, the partially opened cards are prone to falling down flat on the horizontal support surface, especially in response to air currents, thereby defeating their display function.

To counter such drawbacks, my earlier U.S. patent application Ser. No. 11/007,389, filed Dec. 8, 2004, disclosed a suspended greeting card display. Although generally satisfactory for its intended purpose of supporting a suspended display on horizontal, vertical and even inclined surfaces, my proposed use of non-paper supports, such as rigid wires, suction cups, and large, heavy bases, to support the greeting card was disadvantageous in that they made the overall display bulky and heavy and, therefore, expensive to pack and ship, and they required at least some handling and reading of directions on the recipient's part to assemble the display.

### SUMMARY OF THE INVENTION

### Objects of the Invention

Accordingly, it is a general object of this invention to offer new and attractive vehicles for conveying social expression messages.

More particularly, it is an object of the present invention to provide a greeting card display, which takes on aspects of a gift item as well.

Still another object of the present invention is to provide a suspended, mobile, greeting card having multiple freedoms of movement.

It is yet another object of the present invention to reduce the use of non-paper supports to suspend a greeting card, thereby reducing the weight, bulk, and packing and shipping costs of the display.

An additional object of the present invention is to reduce the amount of handling necessary to set up a suspended, mobile, greeting card display.

### Features of the Invention

In keeping with the above objects and others, which will become apparent hereinafter, one feature of the present invention resides, briefly stated, in a suspended, mobile display including a mobile having a plurality of sheet material panels for bearing indicia to be displayed; and a support for suspending the mobile for free swinging movement, including a frame supportable on a generally horizontal support surface in a display position, and an elongated support element mounted on the support above the mobile for hanging the mobile for free swinging movement relative to the support in the display position.

In the preferred embodiment, the panels have surfaces on which the indicia are applied as a greeting card message. At least one of the surfaces may be provided as a writing surface on which at least a part of the message is written. The indicia include artwork and/or text. A plurality of flexible strings is also advantageously provided, each string being connected to at least one of the panels.

Also, in the preferred embodiment, the frame includes a pair of support frames movable from the display position in which the support frames are moved apart from each other, to a compact, generally flattened position in which the support frames are moved toward each other for compact storage and transport. At least one of the support frames has a plurality of frame elements bounding an opening, preferably rectangular, through which the mobile is freely movable and viewable. The support frame with the opening has an upper and a lower frame element parallel to each other, and a pair of side frame elements parallel to each other and extending between the upper and lower frame elements.

In a first embodiment, both support frames bound a respective rectangular opening. The upper frame element of one of the support frames is hingedly connected along an upper horizontal hinge axis to the upper frame element of the other of the support frames. The support includes base flaps respectively connected to the lower frame elements of the support frames. The base flaps are hingedly connected together along a lower horizontal hinge axis that lies in a common vertical plane with the upper hinge axis. The support frames and the base flaps are of one-piece construction, preferably of a paper sheet stock. The frame has a vertical axis of symmetry, and each support frame lies in a plane inclined relative to the vertical axis of symmetry in the display position.

Preferably, the elongated support element is a tether, advantageously a flexible string. In the first embodiment, the support includes at least one fastener for adjusting a length of the tether to position the mobile relative to the support to an adjusted position, and for fixing the mobile in the adjusted position. The at least one fastener includes a passage through which the tether is slidable with a friction fit, and a pressure sensitive adhesive for securing the at least one fastener to the support.

In a second embodiment, only one of the support frames bounds a rectangular opening. The other support frame is a solid, non-apertured sheet. The side frame element of the one support frame is hingedly connected along an upright hinge axis to a side of the other of the support frames. The support includes a bottom lock bar for locking the support frames in a spaced-apart relationship in the display position. The elongated support element is advantageously a rigid or semi-rigid wire mounted on the support, preferably along the upright hinge axis. The shape-retaining wire is connected to the mobile. The wire and the mobile are jointly movable up or down along the upright hinge axis for height adjustment, as well as from side-to-side in opposite circumferential directions about the upright hinge axis for angular adjustment.

In accordance with this invention, if the mobile is exposed to air currents, the display of this invention does not fall over as in some of the prior art discussed above, but instead, the mobile moves with multiple freedoms of movement, thereby creating an animated display. Also, the frame is mostly constituted of paper stock that reduces its weight and bulk compared to the non-paper supports as in some of the prior art discussed above. The movement of the support to the compact position in which the support frames are folded together and assume a closed, generally flattened condition reduces the bulkiness of the display, thereby making it less expensive to pack, store and ship. The movement of the support to the display position in which the support frames are unfolded and assume an open, spread-apart condition is easy to perform and requires no special instructions or handling expertise on the part of the recipient.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a stack of one embodiment of greeting card displays according to this invention, each display being in a compact position suitable for packing, storage and shipping;

FIG. 2 is a side elevational view of the display of FIG. 1, on an enlarged scale;

FIG. 3 is a perspective view of one of the greeting card displays of FIG. 1 in a display position;

FIG. 4 is a sectional view as taken on line 4-4 of FIG. 3, on an enlarged scale;

FIG. 5 is a rear elevational view of the display of FIG. 3, on a reduced scale;

FIG. 6 is a sectional view as taken on line 6-6 of FIG. 5, on an enlarged scale;

FIG. 7 is a perspective view of another embodiment of a greeting card display in a display position according to this invention;

FIG. 8 is a top plan view of FIG. 7;

FIG. 9 is a sectional view as taken on line 9-9 of FIG. 8, on an enlarged scale;

FIG. 10 is a sectional view as taken on line 10-10 of FIG. 8, on an enlarged scale;

FIG. 11 is a sectional view as taken on line 11-11 of FIG. 10, on an enlarged scale; and

FIG. 12 is a sectional view as taken on line 12-12 of FIG. 8.

### DETAILED DESCRIPTION OF THE PREFERRED EMBODIMENTS

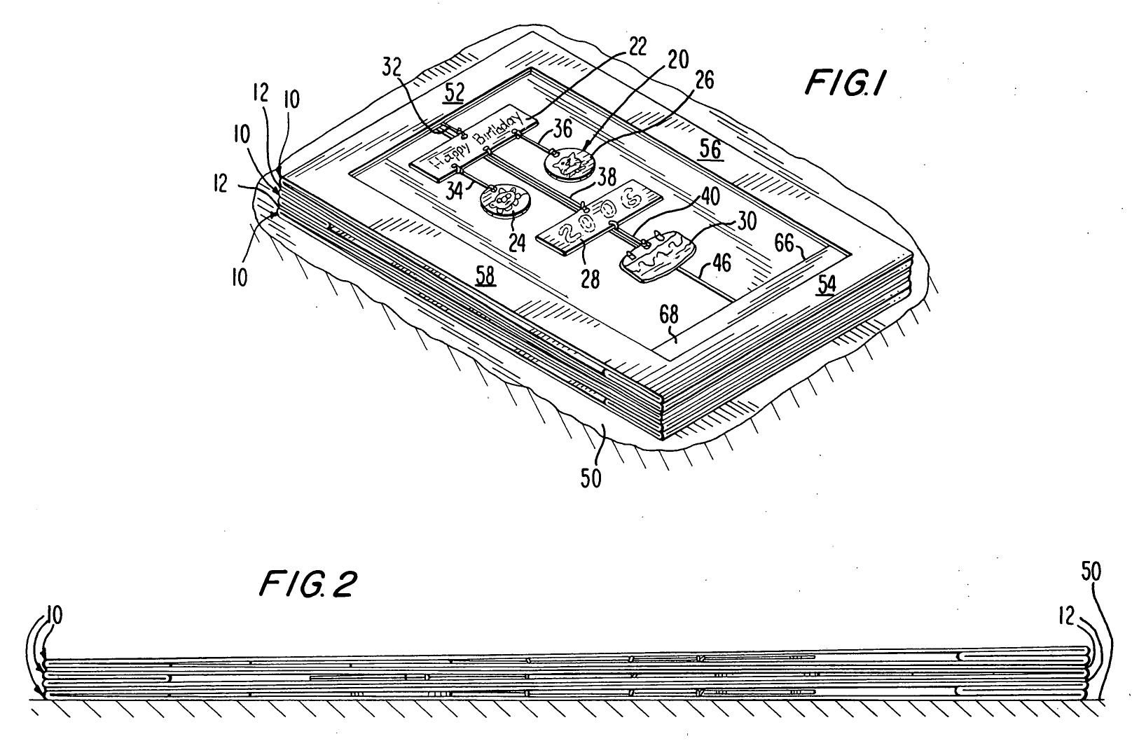

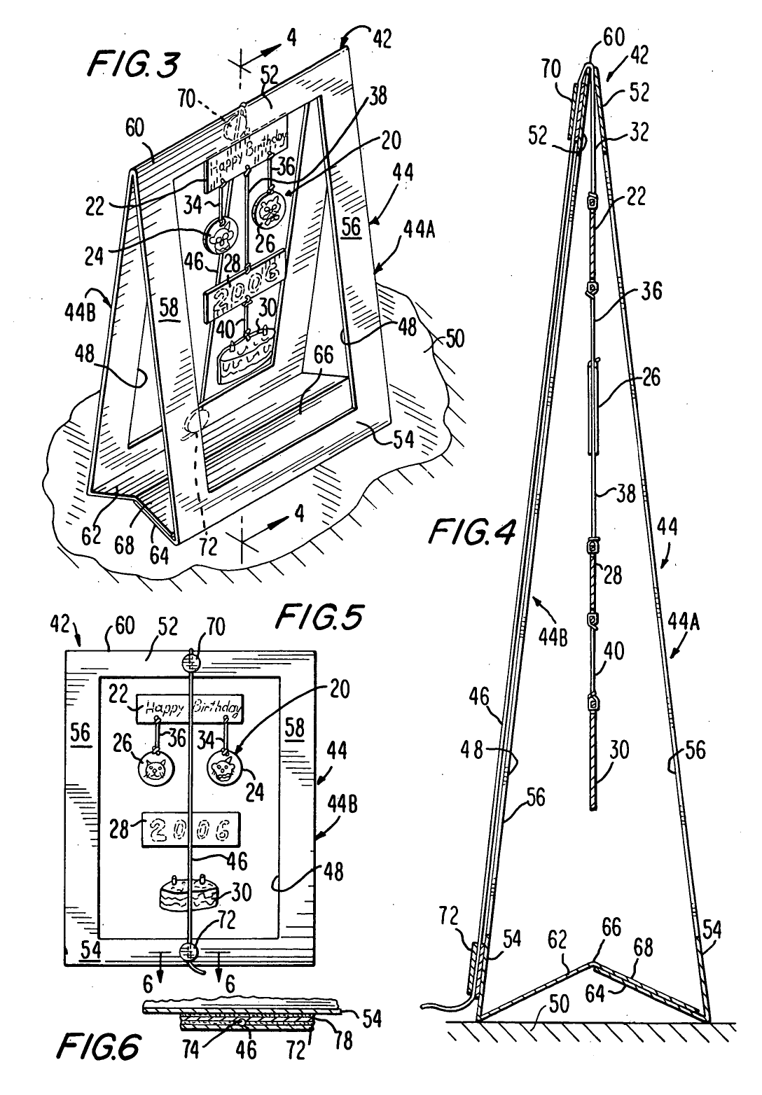

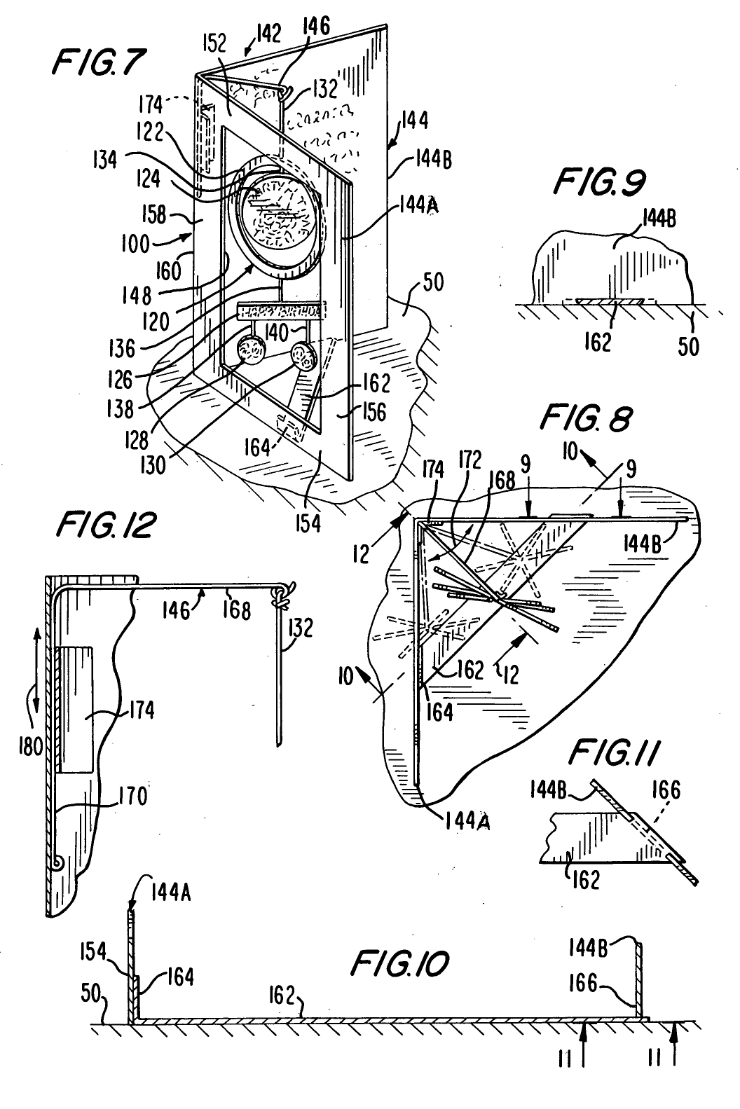

FIGS. 1-2 depict a vertical stack of a plurality of suspended, mobile, greeting card displays 10, each in a compact, folded, generally flattened closed condition suitable for storage and transport, and FIGS. 3-6 depict a representative one of the displays 10, in accordance with one embodiment of this invention, in an unfolded, spread-apart, open display position suitable for being supported for display purposes on a generally horizontal support surface 50, such as a desk, shelf or mantel, etc.

As best seen in FIGS. 1, 3 and 5, the display 10 includes a mobile 20 having a plurality of planar sheet material panels 22, 24, 26, 28, 30 for bearing indicia to be displayed. The panels have surfaces on which the indicia are applied as a greeting card message. One of the surfaces may be left blank and serve as a writing surface on which at least a personalized part of the message is written. The indicia include artwork and/or text. A preprinted commercial message can be imprinted on one or more panels of the mobile, or all the panels can be left blank for receipt of a customized, handwritten message.

The mobile 20 further includes a plurality of strings 32, 34, 36, 38, 40. String 32 is connected to the upper panel 22, and each of the other strings interconnects a pair of the panels, as illustrated. Each string is flexible and allows the panels to move relative to each other. The strings suspend the panels at various elevations. Since the panels have freedom of movement due to the flexible strings even in the compact position, to prevent the mobile of one display 10 from becoming entangled with the mobile of an adjacent stacked display 10 in FIGS. 1-2, a plurality of separator sheets 12 are positioned between the mobiles 20.

Each display 10 further includes a support 42 for suspending the respective mobile 20 for free swinging movement, including a frame 44 supportable on the generally horizontal support surface 50 in the display position, and an elongated support element, such as a tether 46 mounted on the support 42 above the mobile 20 for hanging the mobile 20 for free swinging movement relative to the support 42 in the display position. The frame includes a pair of support frames 44A, 44B movable about a horizontal axis from the display position in which the support frames 44A, 44B are moved apart from each other, to a compact, generally flattened position in which the support frames 44A, 44B are moved toward each other for compact storage and transport.

Each support frame 44A, 44B has a plurality of frame elements bounding an opening 48, preferably rectangular, through which the mobile 20 is freely movable and viewable. Other shapes for the opening 48 are also contemplated. Each support frame 44A, 44B has an upper 52 and a lower 54 frame element extending parallel to each other along one direction, and a pair of side frame elements 56, 58 extending parallel to each other in a perpendicular direction and extending between the upper and lower frame elements 52, 54.

The upper frame element 52 of one of the support frames 44A is hingedly connected along an upper horizontal hinge axis 60 to the upper frame element 52 of the other of the support frames 44B. The support 42 includes base flaps 62, 64 respectively connected to the lower frame elements 54, 54 of the support frames 44A, 44B. The base flaps 62, 64 are hingedly connected together along a lower horizontal hinge axis 66 that lies in a common vertical plane with the upper hinge axis 60. The support frames 44A, 44B and the base flaps 62, 64 are of one-piece, sheet paper construction. Base flap 62 has an extension 68 that overlies and is adhesively secured to the flap 64.

The support 42 has a vertical axis of symmetry, and each support frame 44A, 44B lies in a plane inclined relative to the vertical axis of symmetry in the display position. As seen in the side view of FIG. 4, the support 42 in the display position has a generally triangular shape with a wide base for stability and a pointed top.

As previously stated, the tether 46 suspends the mobile 20. Advantageously, the tether 46 is a flexible string that merges integrally with the string 32. The tether includes at least one fastener 70, 72 operative for adjusting a length of the tether 46 to position the mobile 20 relative to the support 42 to an adjusted position, and for fixing the mobile 20 in the adjusted position. Each fastener 70, 72 includes a passage 74 (see FIG. 6) through which the tether 46 is slidable with a friction fit, and a pressure sensitive adhesive 78 for securing the at least one fastener 70, 72 to the frame 44.

In use, a greeting card recipient is presented with the display of FIG. 1 in the compact, closed state. For this purpose, the display is advantageously placed in an envelope for removal by the recipient. The recipient need only unfold the support 42 by moving the support frames 44A, 44B apart about the hinges 60, 66 until the interconnected base flaps 62, 64 prevent further movement of the support frames away from each other. The recipient then places the unfolded display on the horizontal support surface 50. The greeting card is always in view, even when subjected to air currents, which only serve to enhance and animate the display.

If necessary, the recipient can adjust the elevation of the mobile 20 in the opening 48 by shortening or lengthening the tether 46. For example, the tether can be pulled through the passages 76 until the desired elevation is reached. The tether is held in its final position due to the tight friction fit between the tether and the passages. Any excess length of the tether can be wrapped around one or both of the fasteners 70, 72 not only for neatness, but also for preventing slippage of the tether in the passages.

FIGS. 7-11 depict another embodiment of the display 100 in the unfolded, spread-apart, open display position suitable for being supported for display purposes on the generally horizontal support surface 50. As before, the display 100 includes a mobile 120 having a plurality of planar sheet material panels 122, 124, 126, 128, 130 for bearing indicia to be displayed. The panels have surfaces on which the indicia are applied as a greeting card message. One of the surfaces may be left blank and serve as a writing surface on which at least a personalized part of the message is written. The indicia include artwork and/or text. A preprinted commercial message can be imprinted on one or more panels of the mobile, or all the panels can be left blank for receipt of a customized, handwritten message. The mobile 120 further includes a plurality of strings 132, 134, 136, 138, 140. String 132 is connected to the upper panel 122, and each of the other strings interconnects a pair of the panels, as illustrated. Each string is flexible and allows the panels to move relative to each other. The strings suspend the panels at various elevations.

The display 100 further includes a support 142 for suspending the mobile 120 for free swinging movement, including a frame 144 supportable on the generally horizontal support surface 50 in the display position, and an elongated support element such as a rigid or semi-rigid wire 146 mounted on the support 142 above the mobile 120 for hanging the mobile 120 for free swinging movement relative to the support 142 in the display position. The frame includes a pair of support frames 144A, 144B movable about a vertical axis from the display position in which the support frames 144A, 144B are moved apart from each other, to a compact, generally flattened position in which the support frames 144A, 144B are moved toward each other for compact storage and transport.

Support frame 144A has a plurality of frame elements bounding an opening 148, preferably but not necessarily rectangular, through which the mobile 120 is freely movable and viewable. Support frame 144 has an upper 152 and a lower 154 frame element extending parallel to each other along one direction, and a pair of side frame elements 156, 158 extending parallel to each other in a direction perpendicular to the one direction and extending between the upper and lower frame elements 152, 154. Support frame 144B is a solid sheet, but could, if desired, also be formed with a rectangular opening. Additional text and/or artwork may be provided on the support frame 144B. The solid support frame 144B eliminates the requirement for the separator sheets 12 mentioned above.

The side frame element 158 of the support frame 144A is hingedly connected along a vertical hinge axis 160 to the side of the support frame 144B. The support 142 includes a lock bar 162 hingedly connected at one end region to a base flap 164 that is connected to the lower frame element 154 of the support frame 144A. The opposite end region of the lock bar 162 is formed with a slot 166 for snugly receiving a bottom edge of the support frame 144B for locking and maintaining the display in the display position. The support frames 144A, 144B and the lock bar are of sheet paper construction.

As previously stated, the support wire element 146 suspends the mobile 120. Advantageously, the support wire element 146, as best seen in FIG. 12, is a bent wire having a horizontal overhead portion 168 connected to the string 132, and a vertical mounting portion 170 perpendicular to the overhead portion 168 and mounted on the support by a journal 174 to enable the support wire element 146 to perform one or two movements. The first is a swinging arcuate movement in opposite circumferential directions depicted by the double-headed arrow 172 in FIG. 8 about the vertical axis 160 to a desired position between the phantom line positions also shown in FIG. 8. The second is a linear up-and-down movement along the vertical axis 160 depicted by the double-headed arrow 180 in FIG. 12. The support wire element 146 stays in the desired position to which it is moved due to a friction fit between the mounting portion 170 and the journal 174.

In use, a greeting card recipient is presented with the display of FIG. 7 in the compact, closed state. For this purpose, the display is advantageously placed in an envelope for removal by the recipient. The recipient need only unfold the support 142 by moving the support frames 144A, 144B apart about the vertical hinge 160, and then by unfolding the lock bar 162 to lay in a horizontal plane, and then by fitting the bottom edge of the support frame 144B into the slot 166 of the lock bar 162, and then by swinging the support wire element 146 in either direction 172, and then by raising or lowering the support wire element 146 in either direction 180 until the mobile assumes a desired position, preferably midway between the support frames 144A, 144B and fully viewable through the opening 148 of the support frame 144A. The lock bar 162 prevents further movement of the support frames toward or away from each other. The recipient then places the unfolded display on the horizontal support surface 50. The greeting card is always in view, even when subjected to air currents, which only serve to enhance and animate the display.

If necessary, the recipient can adjust the elevation of the mobile 120 in the opening 148 by shortening or lengthening the string 132.

It will be understood that each of the elements described above, or two or more together, also may find a useful application in other types of constructions differing from the types described above.

While the invention has been illustrated and described as embodied in a suspended, mobile, greeting card display, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A suspended, mobile display, comprising:
a) a mobile having a plurality of sheet material panels for bearing indicia to be displayed; and
b) a support for suspending the mobile for free swinging movement, including a frame supportable on a generally horizontal support surface in a display position, and an elongated support element mounted on the support above the mobile for hanging the mobile for free swinging movement relative to the support in the display position.

2. The display of claim 1, wherein the panels have surfaces on which the indicia is applied as a greeting card message.

3. The display of claim 2, wherein at least one of the surfaces is a writing surface on which at least a part of the message is written.

4. The display of claim 1, wherein the indicia includes at least one of artwork and text.

5. The display of claim 1, wherein the mobile includes a plurality of strings, each string connected to at least one of the panels.

6. The display of claim 1, wherein the frame includes a pair of support frames movable from the display position in which the support frames are moved apart from each other, to a compact, generally flattened position in which the support frames are moved toward each other for compact storage and transport.

7. The display of claim 6, wherein at least one of the support frames has a plurality of frame elements bounding an opening through which the mobile is freely movable and viewable.

8. The display of claim 7, wherein the opening is rectangular.

9. The display of claim 7, wherein the at least one support frame has an upper and a lower frame element parallel to each other, and a pair of side frame elements parallel to each other and extending between the upper and lower frame elements.

10. The display of claim 9, wherein the upper frame element of the at least one support frame is hingedly connected along an upper horizontal hinge axis to the other of the support frames.

11. The display of claim 9, wherein one of the side frame elements of the at least one support frame is hingedly connected along an upright vertical hinge axis to the other of the support frames.

12. The display of claim 6, wherein each support frame has an upper and a lower frame element parallel to each other, and a pair of side frame elements parallel to each other and extending between the upper and lower frame elements, and wherein the upper frame elements are hingedly connected along an upper horizontal hinge axis, and wherein the support includes base flaps respectively connected to the lower frame elements of the support frames, and wherein the base flaps are hingedly connected together along a lower horizontal hinge axis that lies in a common vertical plane with the upper horizontal hinge axis.

13. The display of claim 12, wherein the support frames and the base flaps are of one-piece, sheet paper construction.

14. The display of claim 6, wherein the frame has a vertical axis of symmetry, and wherein each support frame lies in a plane inclined relative to the vertical axis of symmetry in the display position.

15. The display of claim 1, wherein the elongated support element is a flexible string.

16. The display of claim 1, wherein the support includes at least one fastener for adjusting a length of the elongated support element to position the mobile relative to the support to an adjusted position, and for fixing the mobile in the adjusted position.

17. The display of claim 16, wherein the at least one fastener includes a passage through which the string is slidable with a friction fit, and a pressure sensitive adhesive for securing the at least one fastener to the frame.

18. The display of claim 1, wherein the elongated support element includes an overhead support portion connected to the mobile, and a mounting portion mounted on the support to enable the overhead portion and the mobile to be jointly moved along and about a vertical axis.

19. The display of claim 6, wherein the support includes a lock bar for locking the support frames in the display position.

20. The display of claim 19, wherein the lock bar includes one end region connected to one of the support frames, and another end region having a slot for receiving an edge of the other of the support frames.
